(19) United States
(12) Patent Application Publication
(10) Pub. No.: US 2010/0225738 A1
(43) Pub. Date: Sep. 9, 2010

(54) Vehicle Safety Camera System

(76) Inventor: Allen E. Webster, Kent, WA (US)

Correspondence Address: Oliver Law Firm, PS Inc., 1113 Hoyle Ln, Waxhaw, NC, 28173, US

(21) Appl. No.: 12/738,105

(22) PCT Filed: Oct. 29, 2008
(86) PCT No.: PCT/US08/81654

§ 371 Date: Apr. 15, 2010

Related U.S. Application Data
(60) Provisional application No. 61/000,957, filed on Oct. 30, 2007.

(51) Int. Cl. H04N 5/225

(52) U.S. Cl. 348/36; 348/E05.024

(57) ABSTRACT

An externally-mounted camera system for large commercial trucks. The video cameras are positioned around the outside of the vehicle and feed their video images to a control unit within a tamper-proof black box typically located within the truck's cab. The cameras are wide-angle 360 degree type cameras and only four cameras completely surrounding the truck. This system is designed to work with the Federal Motor Carrier Safety Administration and Accident Reporting regulations, standards, and protocols. The video feeds will be attached to accident reports and reviewed by the federal authorities who provide feedback in compiled statistics and enhanced safety regulations.

### RELATED APPLICATIONS

This application is related to and claims priority under 35 U.S.C. 119(e) to U.S. provisional application Ser. No. 61/000,957, entitled “Blind Spot Recording Camera for Vehicles,” filed on Oct. 30, 2007, with inventor Allen Webster, which is hereby incorporated by reference in its entirety.

### FIELD OF THE INVENTION

This invention pertains generally to vehicle safety accessories and more particularly to a system of camera devices used to record activity all around a vehicle, including in the blind spot areas.

### BACKGROUND OF THE FIELD

For many years, there have been problems, esp. with large trucks but also with passenger cars and other vehicles, concerning driving activity—mainly turns and changing lanes. There is typically at least one area on the periphery of the vehicle where the driver cannot see even with mirrors, and this area(s) is called a “blind spot.” There actually may be several blind spot areas for any given vehicle. When automobiles—or other smaller vehicles such as motorcycles—are traveling in a large vehicle's “blind spot,” they do not always understand the intention or simply choose to ignore the intention of the large vehicle's driver, and the large vehicle's driver cannot see them. This creates a dangerous situation which in the past has been responsible for much loss of life and property damage.

The United States federal government has addressed this problem with regulations for truckdrivers as promulgated in the Code of Federal Regulations Title 49. (Other countries have corresponding organizations.) Further, the Federal Motor Carrier Safety Administration (FMCSA) has issued guidelines for interpreting and explaining these regulations for truckdrivers—especially in the Motor Carrier's Guide to Improving Highway Safety and also their many driver training programs. One such regulation states that a truckdriver must signal well in advance of turning or changing lanes, and then must execute the action slowly and carefully. The purpose of this type of regulation is to give the truckdrivers time to view objects in their side mirrors and to consequently make adjustments as necessary to yield the right-of-way if necessary and avoid accidents. When a large truck has an accident, there must be generated an accident report that is submitted to the federal authorities for review (FMCSA). The federal authorities then use this accident report to compile statistics and to grant, deny, or continue driver, vehicle, and company certification. The reports may also be used to enhance current regulations in the Federal Motor Carrier Safety Administration and its drivers' manuals. Accident reports, because written or typed by human personal, can be inadvertently or intentionally mistyped, and so sometimes the federal authorities do not have an accurate report of the accident and events leading up to it.

Various prior art references have tried to address the problem of blind spots, but none have pinpointed the exact issue of the current invention, which is to increase safety on the roads. Many of these prior art references disclose external camera systems that lead to monitoring displays in the cab in the driver's area of view. These monitors may give the driver a view of what is in his blind spot at that instant in time, but this type of system creates two new problems: 1) the driver's eyes are taken off the road, and 2) the driver becomes too dependent on the cameras/monitors and loses judgment.

Specifically, Kawasaki in U.S. Pat. No. 7,254,482 discloses an external monitoring system for vehicles using video cameras. However, Kawasaki's system depends on both/all vehicles in an accident having the same vehicle information recording system, and also on a receiving unit placed outside the vehicle(s). Kawasaki's system uses “can” type video cameras which can only be aimed in a specific direction and so limit the cameras' fields of view. Furthermore, Kawasaki's system relies on the operator/driver to turn on the cameras at all. In contrast, the current invention uses 360° recording video cameras to capture an overlapping view of the entire 360 degrees around the vehicle and are either always on (when the vehicle's ignition is engaged) or are activated by the vehicle's turn signal, brake, or some other input—so that the driver/operator does not have any control over the system and the recordings' integrity is preserved. In addition, Kawasaki does not mention infra-red or any night-recording problems—nor indeed any night-recording events. Kawasaki assumes that all accidents will occur during the daytime.

U.S. Patent Application Publication No. 2007/0088488 to Reeves et al. discloses a vehicle safety system in which video cameras mounted externally to the vehicle are not on continuously but are activated by certain sensed conditions (e.g., outside object proximity or vehicle brake signal). However, as in Kawasaki, Reeves' system uses can-type video cameras that are limited in scope because they are not on continuously and must aim/tilt/zoom/pan (when that functionality is even available). Reeves also does not mention infra-red or any night-recording problems. Kawasaki and Reeves disclose systems that may record accident activity, but neither makes the roads any safer or provides feedback to the motorists.

Englander, in U.S. Patent Application Publication No. 2008/0122597, discloses an external monitoring system for school buses. Englander's system also uses can-type cameras that are limited in scope; indeed, Englander's system uses at least two rear-mounted forward-facing cameras in order to provide all of the views necessary to obtain the view around the vehicle. Due to the type of cameras in Englander and the other prior art, the video captures must be matched up and synthesized by software or the operator to provide the entire view desired. Once again, Englander's system encourages the driver/operator to take his eyes off the road and to rely on cameras instead of judgment, and although Englander's system may make the schoolchildren safer at a specific point in time, it does not make the driver a safer driver.

Although Englander's system is equipped with infra-red to provide night-lighting for the cameras to be used in the dark, it is inferior to the Applicant's system. Specifically, Englander's infra-red illuminators are pointed in a specific direction to light a specific target or area and need manual manipulation to change directions. Applicant's infra-red system needs no manual manipulation but is all automatic and can illuminate the entire area for the 360° video cameras.

### SUMMARY OF THE INVENTION

The present invention solves the above-mentioned problems by providing an effective way to make the roads safer and encourage safe sharing of the roads by passenger cars and large trucks. The present invention aids the federal and other authorities in accident investigation of accidents involving large trucks and to generate feedback to those drivers, their companies, and the Federal Motor Carrier Safety Administration (FMCSA) or other federal authorities. This will aid in accurate statistics as well as accurate vehicle, driver, and company certification. As an additional result it will provide feedback to help make our roads safer, save lives, and minimize property damage. One aspect of the invention is a monitoring and recording feedback system of several recording video cameras mounted externally on a vehicle (typically a large commercial vehicle) and linked to a wireless transmitter recording device that will be able to record the feeds from the cameras that are activated. These recording cameras will typically be mounted on the front area, rear area, and left and right side mirrors of the vehicle—in order to cover a 360° area around the vehicle, including all of the vehicle's blind spots. The cameras could be integrally manufactured with the vehicle's outer covering and be permanently attached in these locations. However, it is advantageous for the system to be portable with temporarily-mounted cameras. In order for existing trucks and other commercial vehicles covered by the Federal Motor Carrier Safety Administration to use the system, the cameras must be easily installed and removable—hence the use of magnetic/suction bases, to be discussed later.

One important aspect of this system and method is that the driver will not have access to the control unit. The control unit will be housed in a tamper-proof black box located inside the vehicle, and the computer disk therein will be accessible only to authorized personnel, such as company owners or federal agents. One way to limit this access will be to set passwords, security codes, or passcodes for the control unit's software. Indeed the control unit may be set to record a certain code if the black box detects any attempt at tampering. In this way, the software can record a black box tampering event.

Although the black box and the software therein for accepting and recording the video image data are inaccessible to the driver—in order to preserve the integrity of the data—the cameras themselves will be portable and capable of being mounted temporarily. This portability will be accomplished by providing the cameras with magnetic bases having suction capability—magnetic/suction bases that can be activated for mounting or deactivated for removal from the exterior of the truck. In a preferred embodiment, there are four cameras—one to be mounted on the front, one to be mounted on the left side, one to be mounted on the rear, and one to be mounted on the right side. The front and rear cameras may be mounted proximate the centerline of the truck, but need not be. Because the cameras are capable of recording side-to-side (i.e., 360° around the lens axis), they can actually be placed anywhere on the front and back portions of the truck. The side cameras may be mounted on the side view mirrors so that they will face generally rearward and their viewing areas will overlap with the front camera and will cover the entire side area to the truck body.

The Vehicle Safety Camera System may be set to activate cameras continuously while the ignition is turned on, or may be linked to, e.g., the ignition, brake, or turn signals for activation at certain high-stress times. In a preferred embodiment, the front and rear cameras are continuous (activated by the ignition), and the side cameras are activated by the respective turn signal. Once the system has been set by the authorized personnel, it cannot be altered by the driver.

The cameras to be used in the Vehicle Safety Camera System will be 360° recording video cameras. These cameras may be capable of recording during darkness, hot and cold weather, or other extreme environmental conditions—e.g., strong winds or heavy rain, and will have the scope and range necessary to record the intended field at the requisite distances according to Federal regulations. Furthermore, each camera will comprise infra-red emitters in a 360° circle surrounding the camera lens so that every angle of the cameras viewing and recording scope will be illuminated.

The wireless transmitter recorder located inside the black box inside the vehicle will typically be mounted under the dashboard, but may be located at any other convenient place, such as under a seat or in a motorcycle's control panel. The recordings (usually on electronic disk) may subsequently be made available to safety officers, law enforcement personnel, insurance companies, and/or the vehicle owners.

### BRIEF DESCRIPTION OF THE DRAWINGS

The objects, features, and advantages of the present invention will be apparent to one skilled in the art from reading the following description in which:

FIG. 1A is a side view of a preferred embodiment of the vehicle safety camera system;

FIG. 1B is a top plan view of FIG. 1;

FIG. 2A is a detail view showing a possible mounting of a front video camera;

FIG. 2B is a detail view showing a possible mounting of a rear video camera;

FIG. 3A is a detail view showing a possible mounting of a side camera;

FIG. 3B is a plan view of FIG. 3A;

FIG. 4A is a top view of a 360° video camera;

FIG. 4B is a side view of a 360° video camera;

FIG. 4C is a side view of a prior art “can”-type camera;

FIG. 5 is a block diagram showing the process of using the camera system;

FIG. 6 is a block diagram showing the process of using the data from the camera system; and

FIG. 7 is an overview of a black box for housing the computerized central control unit.

### DETAILED DESCRIPTION

The following specification describes a vehicle safety camera system. In the description, specific materials and configurations are set forth in order to provide a more complete understanding of the present invention. But it is understood by those skilled in the art that the present invention can be practiced without those specific details. In some instances, well-known elements are not described precisely so as not to obscure the invention.

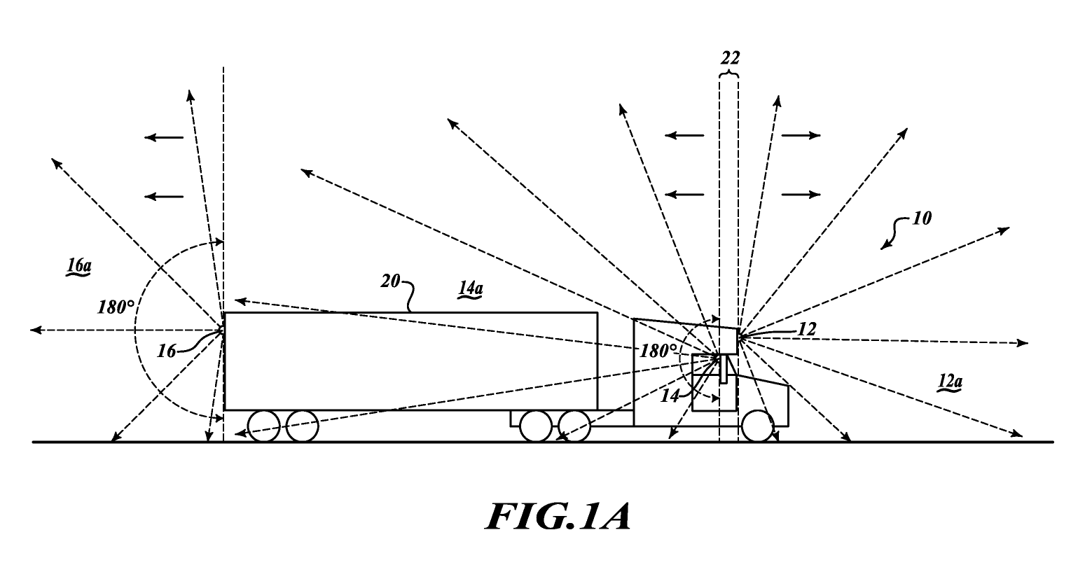

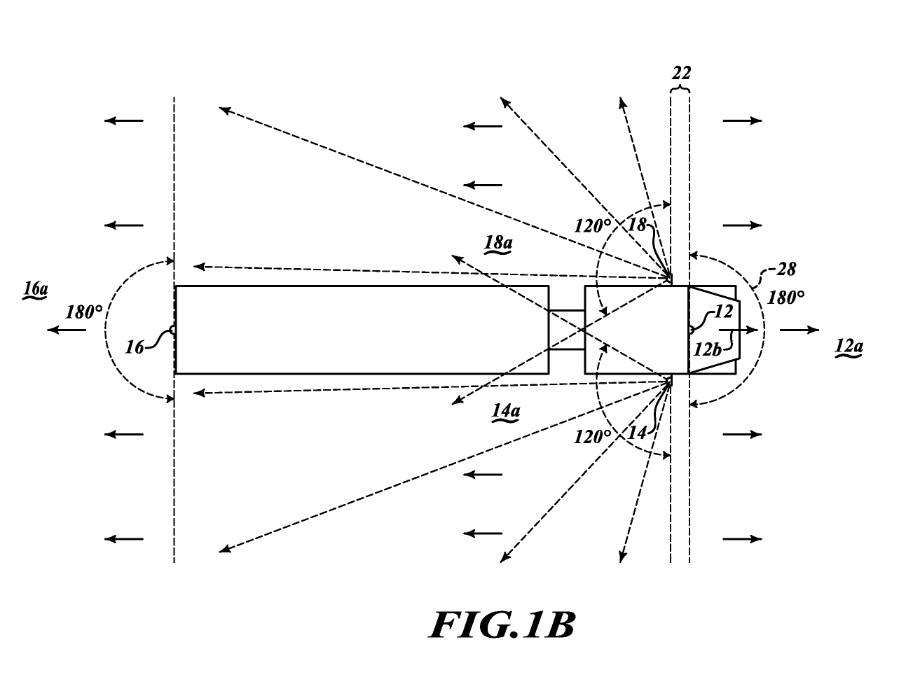

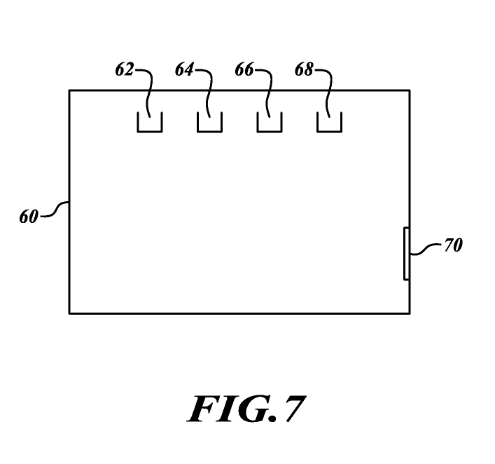

FIG. 1A shows a possible arrangement of the vehicle safety camera system, more specifically known as an external monitoring and recording feedback system 10. In this preferred embodiment of the monitoring system, there are four recording cameras 12, 14, 16, and 18 mounted respectively on the front area, right side (typically adjacent the right side mirror), rear area, and left side (typically adjacent the left side mirror and shown in FIG. 1B) of a vehicle 20 and linked wirelessly to the black box 70 (shown in FIG. 7) installed inside the vehicle (typically in the cab). The system has been initially designed for large commercial trucks that are covered by the Federal Motor Carrier Safety Administration; however, the system could also be used for trucks that are covered by another country's appropriate organization or on smaller trucks, or passenger vehicles, such as cars and motorcycles. Also, a different number of cameras than four could be used; however four has been chosen as the optimal number for this preferred embodiment, because four cameras of this wide-angle type can give complete or nearly complete coverage around the vehicle.

Each video camera 12, 14, 16, 18 is a wide-angle, 360° recording type camera and is positioned so as to capture a large coverage area of streaming video image data from one aspect of the vehicle, including the vehicle's blind spots where, e.g., the driver cannot see even with mirrors and/or accidents are statistically likely to occur. The typical capture areas are shown respectively as 12a, 14a, 16a, and 18a, and effectively cover the desired areas around the vehicle. As can be seen from the illustration, the coverage areas often overlap, adding perspective to accident investigation. Also, as can be seen from the illustration, the limits of the coverage areas extend at right angles from the camera lens axes, such as the front camera axis noted as 12b. The cameras themselves will be certified to capture accurate video for a certain distance in every direction from the camera lens—at least two truck lengths. Regulations and guidelines promulgated by the FMCSA may require that the camera system be able to record activity at least two vehicle lengths in front of and behind the vehicle and across at least two lanes on either side. The 360° type camera is capable of capturing video from this mandated coverage area without re-orienting or re-aiming the camera. Such coverage is not possible with the “can”-type cameras of the prior art without re-orienting of re-aiming the camera.

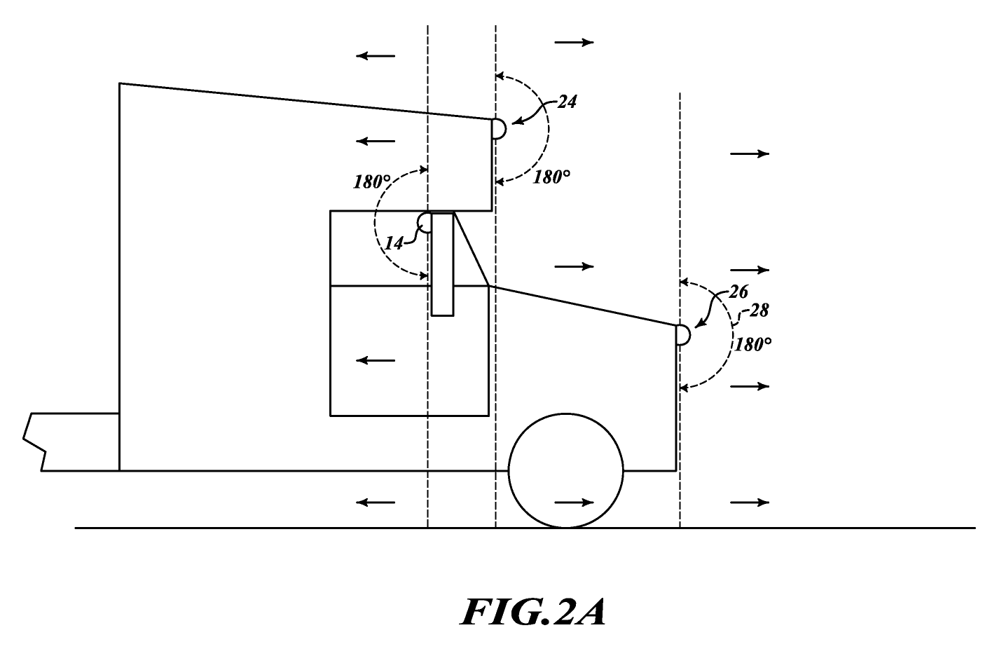

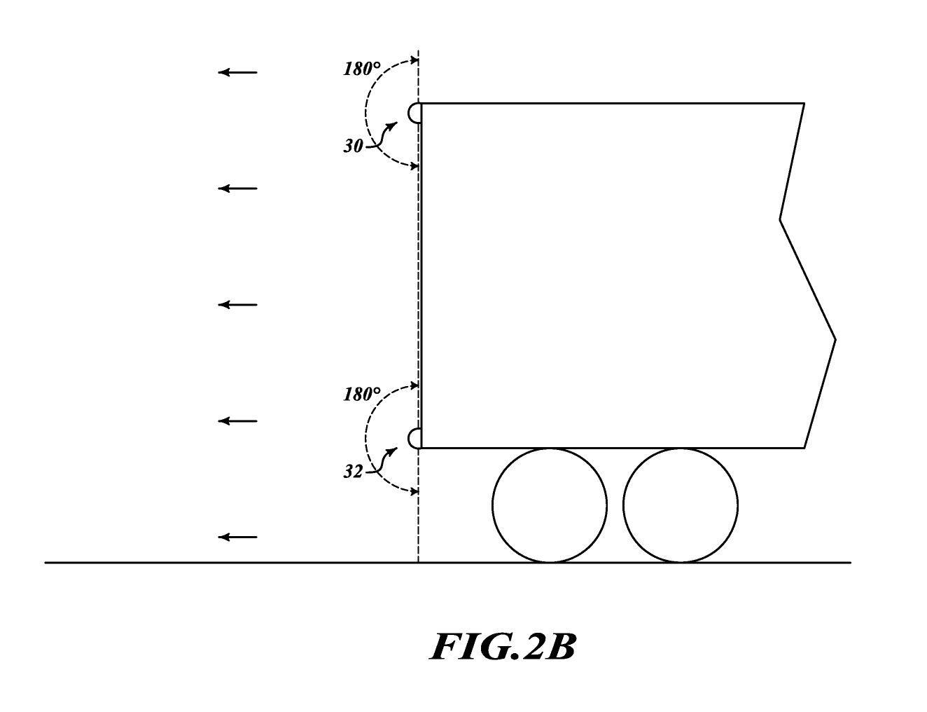

In FIG. 1A, there is a gap 22 between the coverage area 12a from the front camera 12 and the coverage area 14a from the side camera 14. Depending on the truck configuration and the relative placement of the cameras, this gap 22 may be minimized or indeed eliminated. Although the gap 22 represents a break in the coverage surrounding the vehicle—and prevents it from being completely 360° around—it is a minimal gap in a location that is not critical for observation. An ideal location 24 for the front camera 12 may be in the center of the top of the front area (which may be the windshield), and this location 24 may actually be behind the right side camera 14—effecting an overlap of coverage areas. An alternative location 26 (shown in FIG. 2A) for the front camera may be on the grille which creates more of a gap 22, but again, this gap 22 is in a relatively non-critical part of the coverage area around the vehicle.

The top view of FIG. 1B shows all four cameras 12, 14, 16, and 18. Again the gap 22 is evident. Although the cameras can record a coverage angle 28 of 180° as shown by the dashed lines from the front camera 12, the side cameras 14 and 18 will have their respective coverage areas 14a and 18a limited by the side of the vehicle—hence the approximate angles of 120°. The reader will also notice that each camera's coverage area is not always shown by viewing rays (the dashed lines emanating from the camera lens, but is sometimes shown by the solid arrows pointing in the direction of interest. This is done to only to simplify the drawings and clarify the coverage areas.

FIG. 2A shows two recommended locations for the front camera 12—either on the top of the front area (e.g., windshield) 24 or the top of the grille 26. Obviously, because the mounting means of the cameras are temporary, the cameras can be located in any positions on the exterior of the vehicle where the mounting method—either magnetics or suction—will be effective. However, for optimal coverage and video capture, a center front location is recommended. (This optimal mounting area may depend upon the design of the particular truck cab or vehicle front area.) Additionally, because the coverage angle 28 of this type of camera is 180°, there is no need that the camera be mounted in the exact center, e.g., of the front area. It could be placed off to the side without any attendant degradation in coverage. FIG. 2B shows that the rear camera 16 could be placed anywhere from the top of the rear panel 30, for instance at the top of the loading doors, to the bottom of the rear panel 32, for instance on the vehicle's back bumper. In either case, the coverage area 16a will include the desired area to the rear of the vehicle.

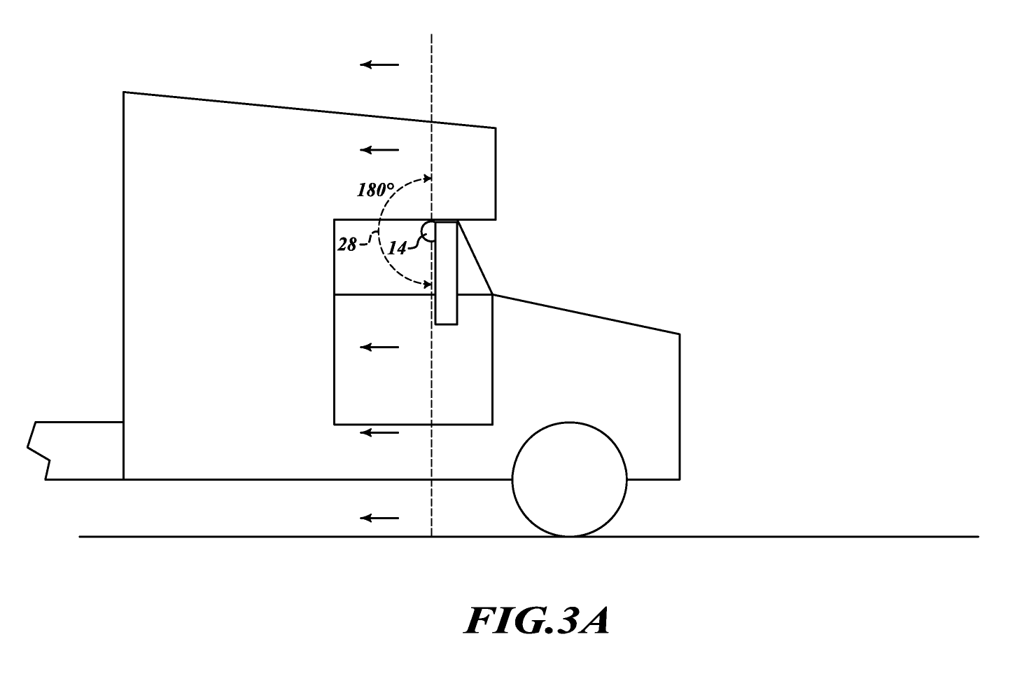

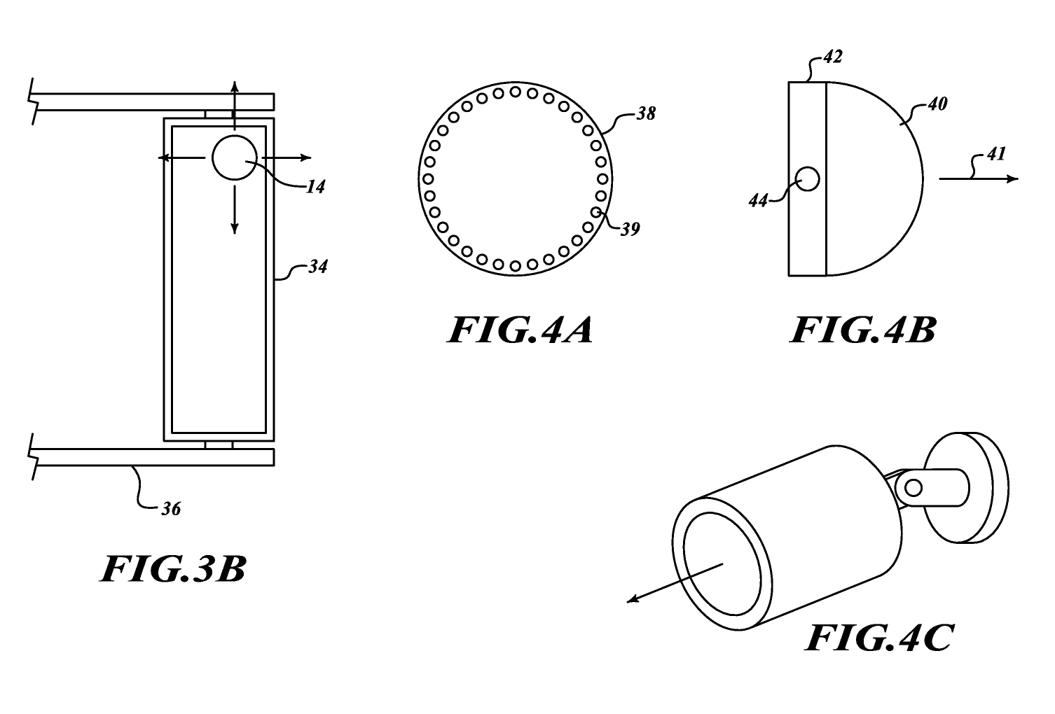

FIG. 3A shows a recommended location for a side camera. In this figure, the right side of the vehicle is shown, and it is understood that the left side of the vehicle is a mirror image thereof and so will not be shown individually. In this illustration, the right side camera 14 is located adjacent the side mirror and may be optimally located on the upper outboard corner of the side mirror 34. The coverage angle 28 is 180° and ensures that coverage area will include the vehicle's blind spot(s) on that side. It is to be noted that the vehicle's driver will not be seeing through the cameras. The driver will instead be keeping his eyes on the road and using his mirrors and judgment. According to the federal regulations as stated by the Federal Motor Carrier Safety Administration (CFR Title 49), a commercial truck driver must change lanes slowly so as to gradually see more and more of the blind spot area in his side mirrors. This slow rate of change ensures that, should a vehicle remain in the vehicle's blind spot (even after the driver has activated his turn signals), the truckdriver will eventually be able to see the vehicle appear in his side mirror and avoid the crash by moving back into his original lane and yielding the right-of-way. The cameras being unavailable to the driver ensures that the driver's eyes stay on the road and that he uses the judgment developed from his certification training. This in itself (without the feedback feature) keeps the roads safer.

FIG. 3B shows a plan view of the recommended location for the side camera 14. In this preferred embodiment, the camera is mounted on the upper outboard corner of the side mirror 34. The base of the camera (shown in FIG. 4B) comprises both magnetics and suction capability. The camera 14 could instead be mounted magnetically to the metal bracket 36 or any other appropriate location. However, it may be a more optimal situation—for enhanced video coverage—for the camera to be mounted on the outboard side of the mirror 34, as in the illustration. In this or similar locations, the camera's suction mount can be used.

As shown in FIG. 4A, the circumference 38 of one of these 360° cameras is generally round. Just inside the lens, there may be a ring of infra-red emitters 39, such as LEDs, for night-time viewing and recording. This ring of emitters ensures that the entire capture area is lighted for recording at all times. There is no need for the driver/operator to turn on the emitters or point, orient, or aim them at all. There is no need for any input whatsoever by the driver/operator. As mentioned above, one of the objects of the invention is that the system is tamper-proof by the driver, and to this end, the cameras will be self-functioning.

As can be seen in FIG. 4B, the camera lens 40 is generally hemispherical and bubbles out from the generally circular base 42 so that the entire camera provides a fairly low profile. The camera lens 40 is generally axisymmetric to the axis 41 which in turn is generally orthogonal to the base 42, resulting in a wide coverage area, approximately 360° around the axis. The button 44 on the side of the base is used to activate the magnetics and/or suction of the base for mounting. (Each camera is equipped with a base having both suction and magnetic capability, so that the cameras may be positioned as desired and mounted as necessary—whether to metal, glass, plastic, or some other mounting surface material.) There may be a similar button 44 on the opposite side of the base (so that there are two altogether), and the buttons 44 act also as release buttons for removing the camera from the mounting location. Pressing the activation buttons secures the camera base to the mounting surface on the exterior of the vehicle, and then pressing the activation buttons again releases the camera base. FIG. 4C shows a “can”-type camera of the prior art. All of the prior art references use this type of camera, which by its construction, is limited in scope and must be directed toward the coverage area to be recorded.

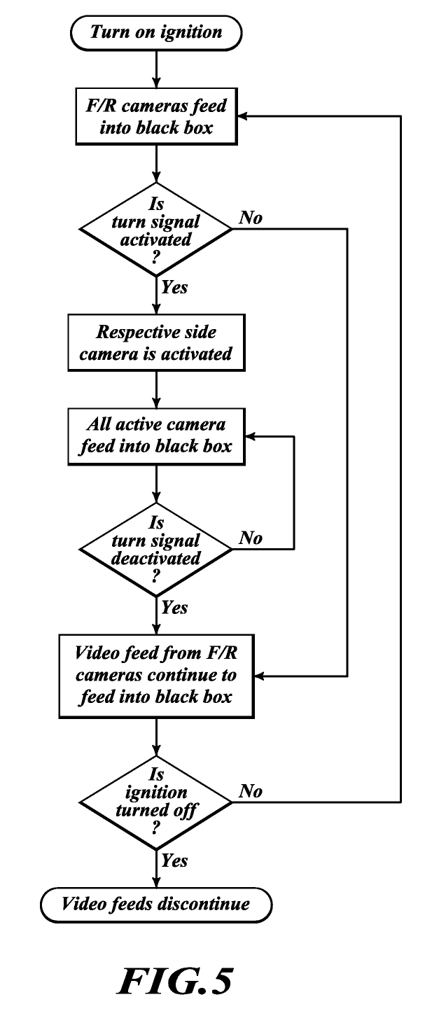

FIG. 5 is a flowchart showing a process of using the external monitoring and recording system to record activity external to the vehicle while the vehicle is in transit. Turning on the ignition automatically activates the Front and Rear (F/R) cameras, so that they begin feeding video into the black box immediately and do not cease until the ignition is turned off. Unless the turn signal is activated, the side cameras will never be activated, and the recorded video will consist of Front and Rear feeds only. However, once the turn signal is activated (for a lane change or right or left turn event), the respective side camera will be activated, and it will begin feeding video into the black box immediately along with the Front and Rear cameras, all videos being time-stamped for late review. The side camera will discontinue when the turn signal clicks off again, but the Front and Rear cameras will continue to record image data and feed into the black box. When the ignition is turned off, the cameras deactivate as well. The recorded images will then reside in the black box until cleared and can be downloaded and used to provide feedback and to enhance road safety. As previously mentioned, the fact that all of this recording is done without any input from the driver, keeps the driver's hands, eyes, and mind on the driving task. That fact also makes the roads safer.

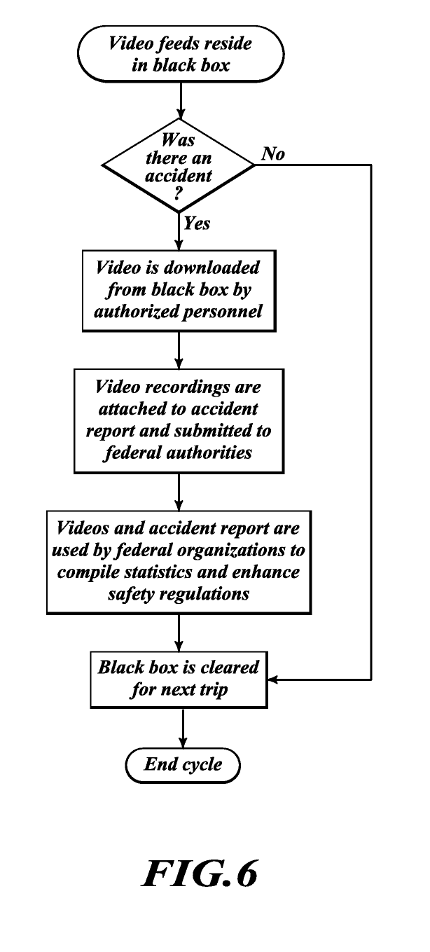

FIG. 6 is a flowchart showing one embodiment of how the image data of the captured video may be used to aid in enhancing road safety. After each truck trip, the video feeds will reside in the black box, and if there was an accident, then there will need to be an accident report. The report will be generated by the driver and currently will be handwritten or printed to be submitted to the federal authorities (typically FMCSA, but in other countries, it would be the appropriate organization). With this camera system, there will be time-stamped video to be added to the written report to further explain the accident and the events leading up to the accident. However, the video data can only be accessed and downloaded by authorized personnel entering a passcode—eliminating any possibility that the driver or any other person could manipulate the data. Reviewers will be able to determine—from the time-stamped images—whether the accident was due to driver error, vehicle inadequacy, the other driver/vehicle involved, or some other reason. The FMCSA or other appropriate organization will use this accident data not only to determine vehicle driver compliance with federal regulations and to compile more detailed statistics, but also to provide feedback to the vehicle owner (individual or company) as to how the driver's training, vehicle's equipment, etc., can be improved, and also to further enhance the federal regulations and guidelines as outlined in, e.g., the Code of Federal Regulations at Title 49 Transportation and the FMCSA's Motor Carrier's Guide to Improving Highway Safety.

The black box 60 that houses the computerized central control unit is shown in FIG. 7. The central control unit (not shown) is to be a conventional transmitter recorder similar to ones in service today. The tamper-proof black box will be manufactured from a material such as titanium that resists tampering and preserves the contents therein through severe climate and/or severe forces, e.g., those due to a severe accident. The tamper-proof black box will be located inside the vehicle, typically in the cab, and will include software for accepting and recording video image data from the wireless 360° recording video cameras. The wireless cameras will be linked wirelessly to the black box so that their respective video feeds will be recorded and time-stamped on magnetic disk therein. For instance, the front camera may be linked to the black box at 62, the right side camera at 64, the left side camera at 66, and the rear camera at 68. Authorized personnel will have access to the magnetic disk, perhaps through USB drive 70, and may download the data, but the vehicle driver/operator will not. In fact, the computerized central control unit and the software may be configured to record any black box tampering event.

What is claimed is:

1. An external monitoring and recording feedback system for a vehicle comprising:
a tamper-proof black box located inside said vehicle including software for accepting and recording video image data; and
a plurality of 360° recording video cameras linked thereto having means for temporarily mounting on the exterior of said vehicle.

2. The feedback system of claim 1 wherein said black box is inaccessible by a vehicle operator and the software records a black box tampering event.

3. The feedback system of claim 1 wherein said recording cameras are linked wirelessly to said black box.

4. The feedback system of claim 3 wherein said means for mounting comprises magnetic and suction bases attached to each video recording camera.

5. The feedback system of claim 1 wherein said recording cameras comprise magnetic and suction bases for mounting to the exterior of said vehicle.

6. The feedback system of claim 1 wherein said plurality of recording cameras consists of four 360° recording video cameras.

7. The feedback system of claim 6 wherein two of said recording cameras are mounted adjacent said vehicle's right and left side mirrors respectively and two of said recording cameras are mounted on the vehicle's front and rear areas respectively.

8. The feedback system of claim 1 wherein each recording video camera has a camera lens defining a lens axis being generally orthogonal to a camera base and is capable of recording streaming video images 360° around said axis.

9. The feedback system of claim 8 wherein said recording cameras further comprise infra-red emitters surrounding said camera lens to light the viewing area continuously.

10. A method for monitoring and recording activity external to a vehicle for the purposes of enhancing road safety using a feedback system, wherein said system comprises a plurality of 360° recording video cameras linked to a computerized central control unit within a black box, said method comprising the steps of:
installing said black box inside said vehicle;
temporarily mounting said recording cameras on the exterior of said vehicle;
linking said recording cameras wirelessly to said control unit within said black box;
activating said system by engaging the vehicle's ignition system; and
recording data fed from said cameras onto magnetic disk within said control unit.

11. The method of claim 10 wherein at least one of said recording cameras is mounted adjacent the left side mirror of the vehicle, at least one of said recording cameras is mounted adjacent the right side mirror of said vehicle, at least one of said recording cameras is mounted on the front area of said vehicle, and at least one of said cameras is mounted on the rear area of said vehicle.

12. The method of claim 11 wherein said recording cameras are positioned so as to record activity surrounding said vehicle including in said vehicle's blind spots and at least two additional lanes in either direction to the side of said vehicle and at least two car lengths in front of and behind said vehicle.

13. The method of claim 12 wherein said data to be fed to said computerized central control unit and recorded therein includes time-stamped streaming video image data from each of said recording cameras.

14. The method of claim 13 wherein said activating step includes activating the front and rear cameras on ignition and activating either side cameras on respective turn signal.

15. A method for using captured video to aid in enhancing road safety wherein said video is captured by a monitoring system using 360° video recording cameras magnetically and suctionally mounted on the exterior of a vehicle and wirelessly linked to a black box located inside said vehicle, said method including the steps of:
temporarily mounting said video cameras by pressing activation buttons on the bases of said cameras to magnetically or suctionally mount said cameras;
recording said video;
storing said video on disk within said black box;
downloading said recorded video from said black box;
attaching said video to an accident report; and
reviewing said video to see the accident happen.

16. The method of claim 15 wherein said video cameras include at least one camera mounted on the front area of the vehicle, at least one camera mounted on the left side of the vehicle, at least one camera mounted on the rear area of the vehicle, and at least one camera mounted on the right side of the vehicle, and said recording step comprises recording continuously from the front and rear cameras and recording from a side camera when the respective turn signal is activated by the driver.

17. The method of claim 16 wherein said downloading step includes entering a passcode known only to authorized personnel, specifically not including the vehicle operator, and said attaching step comprises adding said downloaded video to the accident report filled out and directed to the Federal Motor Carrier Safety Administration.

18. The method of claim 17 wherein the Federal Motor Carrier Safety Administration reviews the video to determine whether the vehicle driver complied with federal regulations.

19. The method of claim 18 wherein the Federal Motor Carrier Safety Administration provides feedback to the vehicle owner.

20. The method of claim 18 wherein the Federal Motor Carrier Safety Administration uses the accident data to enhance federal regulations and guidelines.
